(19) United States
(12) Patent Application Publication
(10) Pub. No.: US 2010/0116650 A1
(43) Pub. Date: May 13, 2010

(54) REMOVAL OF CONTAMINANTS FROM A FLUID

(75) Inventor: John Bostock, Bangor (GB)

Correspondence Address: SALTER & MICHAELSON;THE HERITAGE BUILDING, 321 SOUTH MAIN STREET, PROVIDENCE, RI, 029037128, US

(73) Assignee: AGUACURE LIMITED, Bangor (GB)

(21) Appl. No.: 12/374,416

(22) PCT Filed: Jul. 20, 2007
(86) PCT No.: PCT/GB2007/002794

§ 371 Date: Jan. 13, 2010

(30) Foreign Application Priority Data
Jul. 20, 2006 (GB) 0614389.5

(51) Int. Cl. C02F 1/463

(52) U.S. Cl. 204/277; 204/275.1

(57) ABSTRACT

In the field of fluid treatment, there is a need for a more flexible electrocoagulation unit and a fluid treatment apparatus that is readily configurable to deal efficiently with differently contaminated fluids. An electrocoagulation unit (210), for removing contaminants from a fluid, comprises an electrode chamber, which in use has a top and a bottom. The chamber also has a fluid inlet (14) at or towards its bottom, and is in fluid communication with at least one discharge conduit towards its top to direct fluid from the chamber towards a fluid outlet. The electrocoagulation unit also comprises an electrode module (234) which is removable through the top of the electrode chamber and includes at least one support body that supports a plurality of electrodes (38, 42). The electrode chamber and the electrode module co-operate with one another to restrict the flow of contaminated fluid to regions within the electrode chamber adjacent to active surfaces of the electrodes. A fluid treatment apparatus, for removing contaminants from a fluid, comprises at least one electrocoagulation unit as described above and a separation unit. The electrocoagulation unit and the separation unit are fluidly connected in series.

This invention relates to an electrocoagulation unit, and a fluid treatment apparatus including an electrocoagulation unit, for removing contaminants from a fluid.

It is often necessary to remove contaminants from a fluid, especially water, to render the fluid suitable for further use or discharge into the environment. Contaminants can include metal ions such as arsenic, chromium, copper, cadmium, nickel, lead, and zinc, suspended solids such as silt and clay, dissolved organic compounds, hydrocarbons, dyes, and phosphates.

One way of removing contaminants from a fluid involves adding a chemical additive to the fluid to cause a chemical reaction between the contaminants and the additive such that the contaminants and the chemical additive coagulate into larger particles, which can be removed from the fluid.

One drawback with the use of chemical additives is the creation of a large quantity of residual material that must be disposed of following treatment of a fluid.

As an alternative to the use of chemical additives, it is known to electrolytically treat a contaminated fluid so as to remove contaminants from the fluid in a process called electrocoagulation.

An electrocoagulation unit causes suspended contaminants in a contaminated fluid to coagulate together through the application of an electrical current to the fluid via a plurality of electrodes. This method of removing contaminants reduces the amount of residual material generated.

Through the use of different electrode configurations, or electrodes of different materials, it is possible to remove contaminants differing in nature and composition.

However, in conventional electrocoagulation units, it is difficult to alter the configuration of the anode and cathode electrodes. Consequently, such units generally employ an electrode arrangement that is suitable for removing a wide range of different contaminants from fluids so that the unit may be used with any contaminated fluid. This results in relatively inefficient electrocoagulation units since the electrode arrangement is not specifically chosen for any one specific contaminant.

There is a need therefore for a more flexible electrocoagulation unit that is readily configurable to deal efficiently with differently contaminated fluids.

According to a first aspect of the invention there is provided an electrocoagulation unit, for removing contaminants from a fluid, comprising:
an electrode chamber, which in use has a top and a bottom, the chamber having a fluid inlet at or towards its bottom and being in fluid communication with at least one discharge conduit towards its top to direct fluid from the chamber towards a fluid outlet; and
an electrode module removable through the top of the electrode chamber and including at least one support body supporting a plurality of electrodes,
the electrode chamber and the electrode module co-operating with one another to restrict the flow of contaminated fluid to regions within the electrode chamber adjacent active surfaces of the electrodes.

The electrode module being removable through what, in use, is the top of the electrode chamber means that an operative can remove the electrode module directly from the electrode chamber without having to remove any seals or drain the electrode chamber.

The operative is then able to replace the electrode module with an electrode module having a different configuration of electrodes, or a different type of electrodes. It is thereby possible to provide an electrode module prepared for use with a fluid containing a specific contaminant, or to provide an electrode having a large active electrode surface area, and thereby maximise the efficiency of the electrocoagulation unit.

In addition, restricting the flow of contaminated fluid to regions within the electrode chamber adjacent active surfaces of the electrodes ensures that all contaminated fluid passing through the electrode chamber is acted upon to remove contaminants therefrom, thereby further improving the efficiency of the electrocoagulation unit.

Preferably the or each support body includes a first support member extending through each electrode.

The inclusion of one or more first support members conveniently secures the electrodes relative to one another and creates an electrode module that a user is able readily to handle.

Optionally adjacent electrodes are spaced from one another by at least one spacer member.

Such an arrangement ensures that a user is able easily to vary the spacing between adjacent electrodes through the use of one or more spacers having a desired thickness. As a result a user is able readily to adjust the configuration of the electrode module according to, for example, the viscosity of the contaminated fluid, the size and concentration of suspended solids within the contaminated fluid, or the rate of creation of suspended contaminants within the fluid.

In a preferred embodiment of the electrocoagulation unit the or each first support member passes through one or more corresponding spacer members. This arrangement retains the or each spacer member relative to the electrodes and so aids assembly of an electrode module.

In another preferred embodiment of the invention the electrodes extend laterally so as to lie adjacent to the electrode chamber. The inclusion of such electrodes helps to inhibit the flow of contaminated fluid between inactive edges of the electrodes and the electrode chamber in order to improve the efficiency of the electrocoagulation unit.

Preferably each inactive surface includes a cover member secured thereto so as to lie between the given inactive surface and the electrode chamber. Securing one or more cover members in this manner inhibits the flow of contaminated fluid over each inactive surface, and so further helps to improve the efficiency of the electrocoagulation unit.

An electrocoagulation unit according to a further preferred embodiment of the invention includes a support body that defines a hollow conduit in which the electrodes are located and through which contaminated fluid flows. This arrangement allows the support body to effectively protect the inner surface of the electrode chamber from contact with the contaminated fluid, thereby reducing the build up of suspended contaminant deposits in the electrode chamber and thus helping to ensure that the electrode module is readily removable from the electrode chamber.

The electrode module may be removably located in the electrode chamber such that the support body spaces the electrodes from an inner surface of the electrode chamber.

Spacing the electrodes from the inner surface of the electrode chamber prevents the electrodes coming into contact with the inner surface of the electrode chamber and so reduces the likelihood of the electrodes becoming wedged within the electrode chamber as a result of a build up of suspended contaminant deposits. Wedging of the electrodes within the electrode chamber would inhibit removal of the electrodes from the electrode chamber and so make it difficult to reconfigure the electrocoagulation unit.

The support body may be located adjacent to each inactive surface of the electrodes. This allows the support body to restrict the flow of contaminated fluid to pass over the active surfaces of the electrodes only, thereby increasing the efficiency of the electrocoagulation unit.

Optionally the support body includes two co-operable body portions, which are separable from one another. This arrangement allows an operative to disassemble the electrode module in order to replace a damaged or worn electrode.

In a preferred embodiment, the support body includes at least one side member, the or each side member lying between the two body portions. Such an arrangement provides a convenient way of arranging the support body adjacent the inactive surface of a given electrode.

In another preferred embodiment, the or each support body is or includes a non-conductive material. Particularly desirable non-conductive materials include PVC and recycled plastics.

The electrodes may be formed from or include one or more of the following: aluminium, steel, stainless steel, copper, graphite, reticulated vitreous carbon and a dimensionally stable alloy. Each of these materials is effective at dealing with different contaminants.

Preferably the electrode module further includes at least one second support member, which passes through alternately spaced electrodes. The inclusion of one or more second support members provides the electrodes with additional support when the electrode module is removed from the electrode chamber.

Optionally the electrode module includes a handle secured to at least one second support member to facilitate removal of the electrode module from the electrode chamber.

The electrocoagulation unit may further include a DC power source electrically coupled to the electrode module.

In another preferred embodiment, the electrode module includes a pair of connecting members, each connecting member engaging two or more differing electrodes to define an electrical connection therebetween and being electrically coupled to the DC power source. Such a feature simplifies the connection of an electrical power supply to a group of electrodes.

In a further preferred embodiment, the or each discharge conduit includes at least one weir member lying between the transfer outlet and the discharge outlet. The provision of one or more weir members increases the size of the interface between the contaminated fluid and, e.g. air, in the discharge conduit, thereby improving the exchange of gas, e.g. oxygen, with the contaminated fluid.

In one embodiment, the or each weir member includes a plurality of perforations. The inclusion of a plurality of perforations helps to reduce the likelihood of any gas generated during electrocoagulation becoming trapped underneath a respective weir member.

Optionally the or each discharge conduit includes an aeration member for introducing a gas into any fluid flowing through the given discharge conduit. This enhances the exchange of gas with the contaminated fluid.

The or each discharge conduit may define a helical path. Such an arrangement maintains a laminar flow of fluid discharged from the electrode chamber. This further promotes the coagulation of suspended contaminants in the fluid and so helps to improve the efficiency of the electrocoagulation unit.

Preferably the electrocoagulation unit further includes at least one hydrogen collector. In this way the electrocoagulation unit is able to remove and harvest any hydrogen generated therein.

In one embodiment, the fluid inlet may include at least one inlet member, the or each inlet member including at least one inlet aperture, the or each inlet aperture being directed away from the electrode module to initially direct fluid away from the electrode module. Such an arrangement induces a laminar flow in the fluid flowing through the electrode chamber which results in more efficient operation of the electrocoagulation unit, i.e. less power or less active electrode surface area required to treat a given volume of fluid.

According to another aspect of the invention there is provided a fluid treatment apparatus, for removing contaminants from a fluid, comprising at least one electrocoagulation unit according to any of Claims 1 to 13 and a separation unit wherein the electrocoagulation unit and the separation unit are fluidly connected in series.

This arrangement of fluid treatment apparatus shares the advantages of the electrocoagulation unit of the invention.

Preferably the fluid treatment apparatus includes an electrocoagulation unit including an electrode module having stainless steel electrodes. One benefit of including an electrocoagulation unit which includes an electrode module that has stainless steel electrodes, is that such an arrangement is particularly effective at removing small amounts of aluminium from a fluid passing therethrough.

Optionally the separation unit is or includes a settling tank. A settling tank provides a convenient and cost effective way of removing suspended contaminant particles.

Preferably the separation unit is or includes an air filter including a diffuser for generating a stream of gas bubbles to urge any suspended contaminant particles to a surface of the fluid flowing through the separation unit. Such an arrangement provides a convenient way of removing relatively lightweight contaminant particles.

The separation unit may include an aspirator to suck suspended contaminant particles from an exposed fluid surface into a collection vessel, a skimmer to skim suspended contaminant particles from an fluid exposed surface into a collection vessel, or a decantor to decant suspended contaminant particles from an exposed fluid surface into a collection vessel.

Any of the foregoing features allow for the effective removal of any suspended contaminant particles from an exposed surface of the fluid.

Another embodiment of fluid treatment apparatus may further include a series connected hydrogen peroxide unit having an anode and a cathode. The inclusion of a hydrogen peroxide unit helps to oxidise organic compounds, which may cause oxygen demand, so as to allow for the removal of such compounds from a fluid.

Optionally the anode and the cathode are or include reticulated vitreous carbon. The provision of a reticulated vitreous carbon anode and cathode helps to maximise the active electrode surface area, and thereby improve the efficiency of the electrocoagulation unit.

Alternatively the anode is or includes a dimensionally stable electrode alloy and the cathode is or includes reticulated vitreous carbon. The use of a dimensionally stable electrode alloy helps to prevent electrode degradation. In addition, it is possible to tailor the choice of dimensionally stable alloy so that the gaseous products produced during electrocoagulation enhance the overall electrocoagulation process.

In one embodiment, the hydrogen peroxide unit includes at least one aeration member located upstream of the anode and cathode. The inclusion of an aeration member helps to ensure saturation of the fluid passing through the hydrogen peroxide unit with, e.g. oxygen.

In another embodiment, the hydrogen peroxide unit includes a sacrificial anode for releasing Fe²⁺ ions into the fluid passing through the hydrogen peroxide unit.

In an alternative embodiment, the fluid treatment apparatus includes a fluid conduit between at least one of the electrocoagulation units and the hydrogen peroxide unit to allow the transfer of Fe²⁺ ions from the or each electrocoagulation unit to the hydrogen peroxide unit.

The presence of Fe²⁺ ions in the hydrogen peroxide unit improves the rate of degradation of organic compounds, which allows for the removal of such compounds from the fluid, without the need to chemically add coagulating agents, such as iron salts.

Optionally the fluid treatment apparatus further includes a series connected silver ionisation unit. The inclusion of a silver ionisation unit provides residual disinfection of the fluid passing therethrough.

Preferably the fluid treatment apparatus further includes a power supply module including at least one of the following: a vehicle engine and a renewable energy source. The inclusion of such a power supply module allows for the provision of a portable fluid treatment apparatus.

There now follows a brief description of preferred embodiments of the invention, by way of non-limiting examples, with reference being made to the accompanying drawings in which:

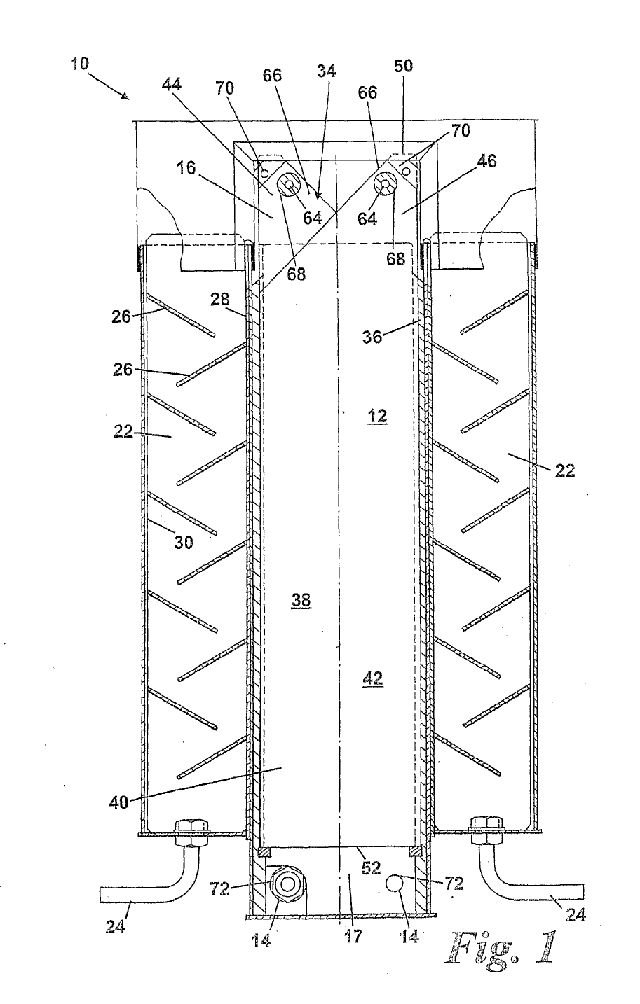

FIG. 1 shows a front elevational, partially sectioned, view of an electrocoagulation unit according to a first embodiment of the invention;

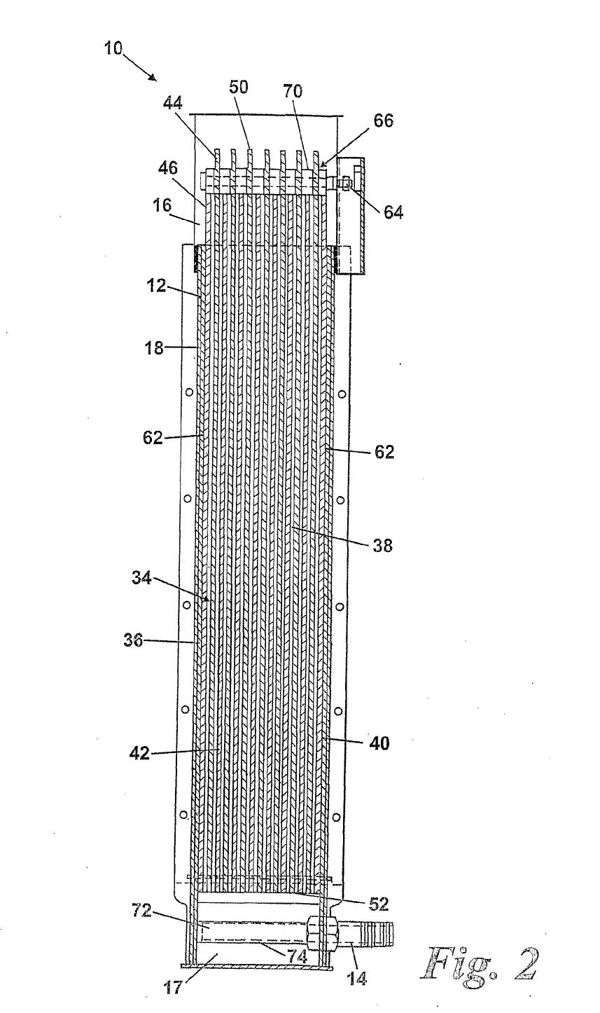

FIG. 2 shows an elevational, sectioned view from one side of the electrocoagulation unit shown in FIG. 1;

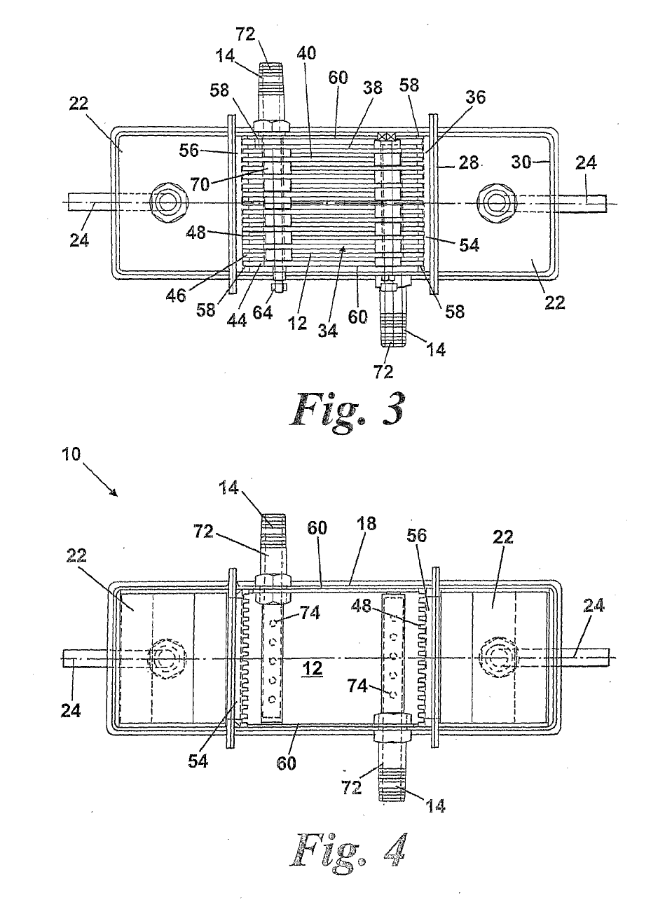

FIG. 3 shows a plan view from above of the electrocoagulation unit shown in FIG. 1;

FIG. 4 shows a plan view from below of the electrocoagulation unit shown in FIG. 1;

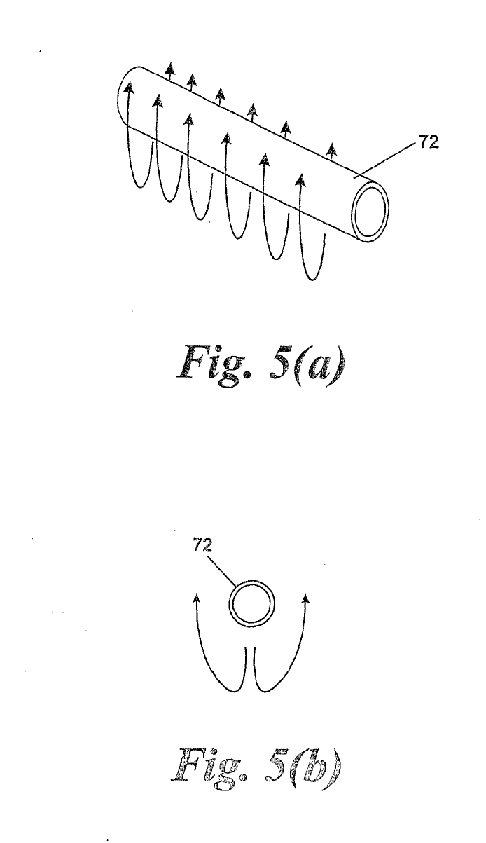

FIG. 5(a) shows a perspective view of an inlet member;

FIG. 5(b) shows an elevational view from one side of the inlet member shown in FIG. 5(a);

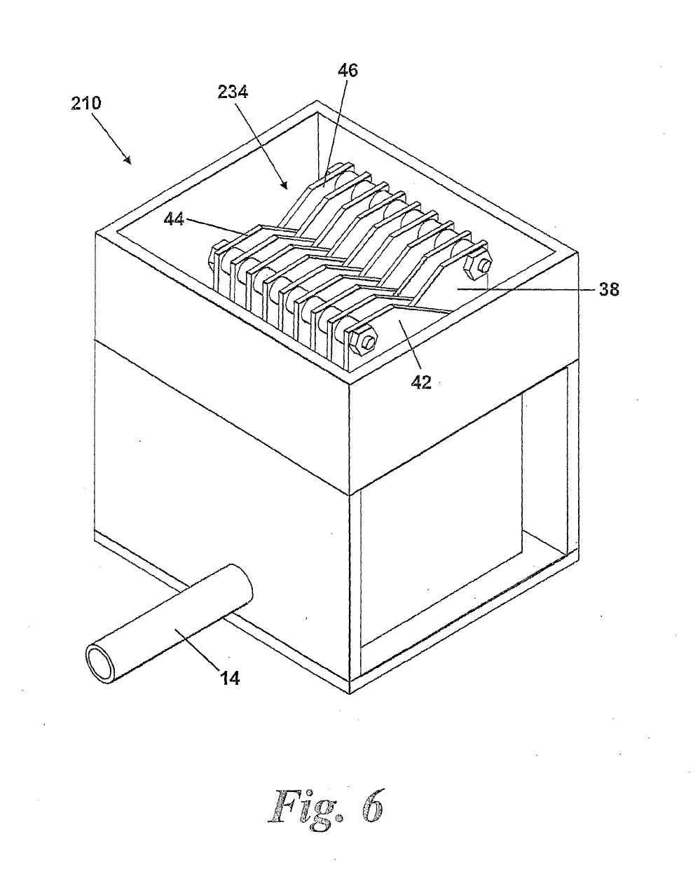

FIG. 6 shows a schematic, perspective view an electrocoagulation unit according to a second embodiment of the invention;

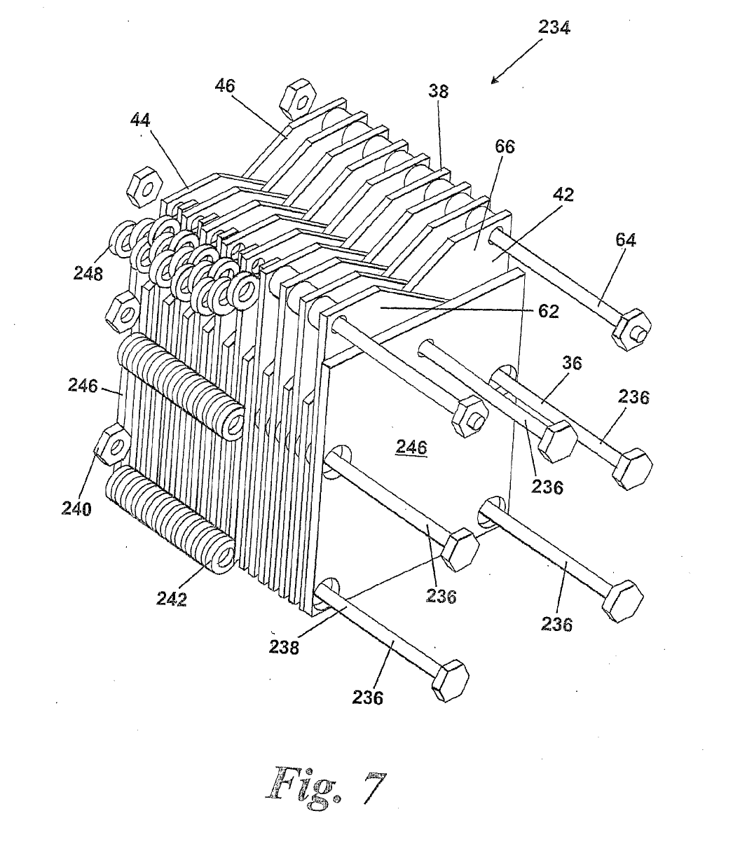

FIG. 7 shows a partially exploded, perspective view of the electrode module shown in FIG. 6;

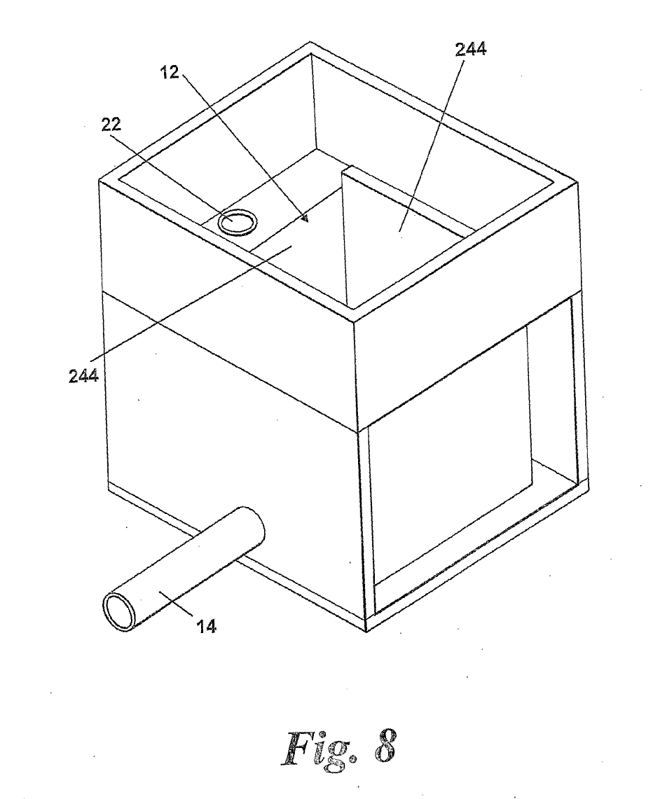

FIG. 8 shows a perspective view of the electrode chamber shown in FIG. 6;

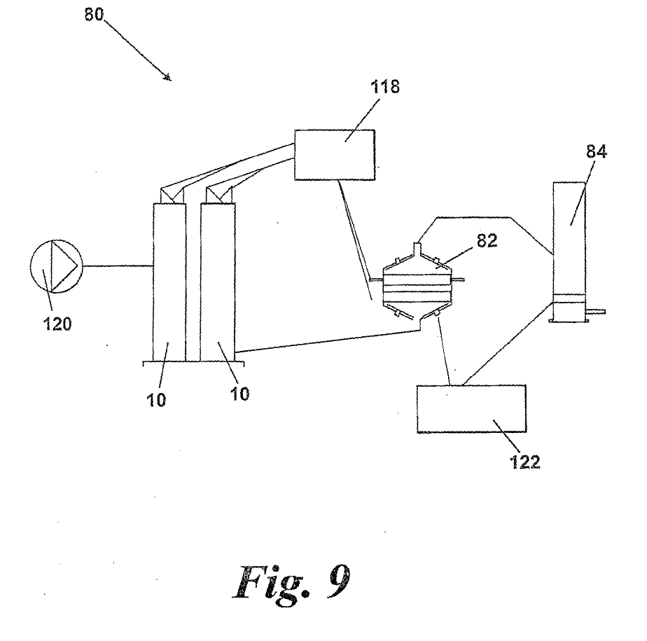

FIG. 9 shows a fluid treatment apparatus according to a first embodiment of the invention;

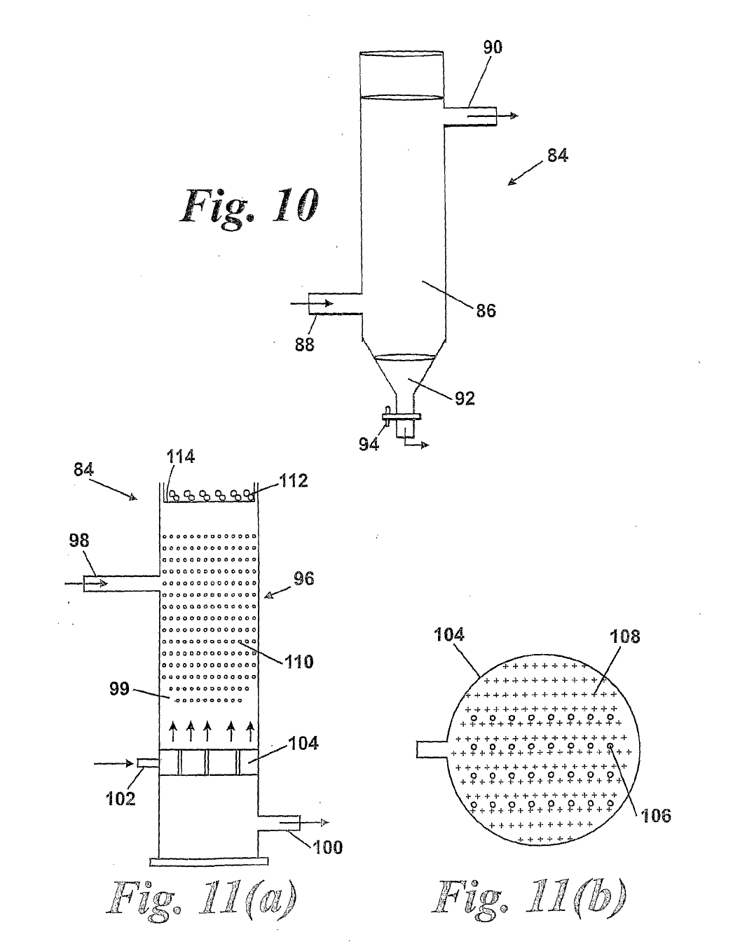

FIG. 10 shows schematic view of a settling tank;

FIG. 11(a) shows a schematic view of an air filter;

FIG. 11(b) shows a schematic view of a diffuser; and

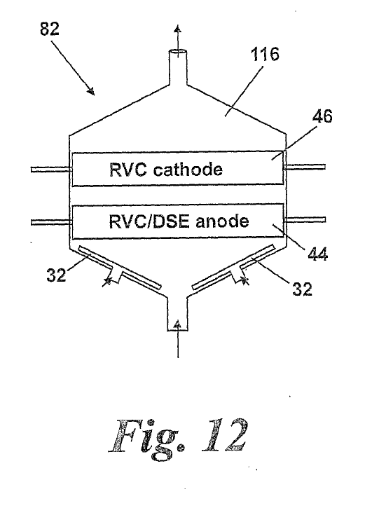

FIG. 12 shows a schematic view of a hydrogen peroxide unit.

An electrocoagulation unit according to a first aspect of the invention is designated generally by the reference numeral 10.

The first electrocoagulation unit 10 includes an electrode chamber 12, which in use has a top 16 and a bottom 17. The top 16 of the electrode chamber 12 is open which allows the electrocoagulation unit 10 to operate at atmospheric pressure. The electrode chamber 12 has two inlets 14 at its bottom 17 and is in fluid communication with two discharge conduits 22 towards its top 16 to direct fluid from the chamber 12 towards respective fluid outlets 24.

In the embodiment shown, each discharge conduit 22 also includes a plurality of inclined weir members 26, which lie between the top 16 of the chamber 12 and the associated fluid outlet 24. Adjacent weir members 26 in each discharge conduit 22 are attached to opposite walls 28, 30 of the discharge conduit 22 so as to define a serpentine path through the discharge conduit 22. Optionally the weir members 26 are slidably received in each discharge conduit 22.

In other embodiments, the arrangement of weir members 26 may differ. For example, a plurality of weir members may adopt a chevron arrangement (not shown) within a given discharge conduit. A discharge conduit may also include one weir member which defines a helter-skelter or spiral path (not shown) within a given discharge conduit.

In still further embodiments of the invention, the or each discharge conduit may define a helical path.

In addition, other embodiments may include one or more discharge conduits that are larger in proportion to the electrode chamber 12 than those shown in FIGS. 1 to 4.

Each discharge conduit 22 also includes an aeration member (not shown) for introducing gas into each discharge conduit 22.

The electrocoagulation unit 10 also includes a hydrogen collector (not shown). The hydrogen collector is preferably located above the top of the electrode chamber 12 so that it is able to remove and collect any gaseous product produced within the electrode chamber 12, or either discharge conduit 22. Collecting any gaseous product in this way enables subsequent recycling or re-use of the gaseous product.

The electrocoagulation unit 10 also includes a first electrode module 34 which is removable through the top of the electrode chamber 12. The first electrode module 34 has a support body 36 that supports a plurality of electrodes 38.

Other embodiments of electrocoagulation unit (not shown) may include a plurality of first electrode modules 34 located within an electrode chamber 12.

In the embodiment shown in FIGS. 1 to 4, the support body 36 defines a hollow conduit 40 in which the electrodes 38 are located, and through which contaminated fluid (not shown) is able to flow.

Each electrode is essentially an elongate plate 42 with a truncated corner. The electrode plates 42 have a smooth surfaces which help to maintain a laminar flow of contaminated fluid through the electrocoagulation unit 10. In other embodiments, it is envisaged that the electrodes 38 may be formed in different shapes.

Adjacent electrode plates 42 are spaced from one another and alternately form an anode 44 and a cathode 46. The arrangement of electrode plates 42 shown, includes iron anodes 44 and aluminium cathodes 46.

Other combinations of electrodes such as iron anodes and cathodes, and aluminium anodes and cathodes are also possible. In addition the anodes and/or cathodes may include steel, stainless steel, copper, graphite, reticulated vitreous carbon and/or a dimensionally stable alloy such as tantalum or titanium. The electrodes may also be formed from a substrate which is coated with titanium.

The support body 36 includes a plurality of recesses 48, each of which slidably receives and supports one side of a respective electrode plate 42 such that adjacent electrodes plates 42 lie substantially parallel to one another. Each end 50, 52 of each electrode plate 42 is exposed at either end of the support body 36.

In a preferred arrangement, each electrode plate 42 is 4 mm thick and is spaced from an adjacent electrode plate 42 by 4 mm. Other arrangements may have different spacings according to the configuration of electrode plates 42 required to deal with a fluid containing a particular contaminant. Other arrangements may also include a different number of electrode plates 42.

In the embodiment shown, the support body 36 includes two co-operable body portions 54, 56, which are separable from one another.

The support body 36 includes two separate side members 60 that extend between the body portions 54, 56, and lie adjacent an inactive surface 62 of each end electrode plate 42.

Each body portion 54, 56 may also include an elongate web (not shown) extending toward the other body portion 54, 56, and lying adjacent the inactive surface 62 of each end electrode plate 42.

Preferably the support body 36 is made from PVC or another non-conductive material, such as a recycled plastic.

The electrode plates 42 are arranged such that a corner 66 of adjacent electrode plates lie on opposite sides of the electrode chamber 12, as shown in FIG. 1.

The support body 36 also includes two second support members 64. Each second support member 64 passes through a hole 68 in the corner 66 of alternate electrode plates 42. In this way, one second support member 64 passes through the anodes 44, and one second support member 64 passes through the cathodes 46.

A handle (not shown) may be secured to each support member 64.

The electrocoagulation unit 10 includes a DC (Direct Current) power source (not shown) that is electrically coupled to the first electrode module 34

The first electrode module 34 further includes two connecting members 70. One connecting member 70 engages the corner 66 of each anode 44 so as to provide an electrical connection between the anodes 44. The other connecting member 70 engages the corner 66 of each cathode 46 so as to provide an electrical connection between the cathodes 46.

The first electrode module 34 is removably received in the electrode chamber 12 such that the support body 36 spaces the electrode plates 42 from an inner surface 18 of the electrode chamber 12.

The inlet 14 of the electrode chamber 12 includes two inlet members 72, each of which includes a plurality of inlet apertures 74. Each inlet aperture 74 is directed away from the first electrode module 34 and so initially directs fluid away from the electrode module 34, as shown in FIGS. 5(a) and 5(b).

In use, the electrode chamber 12 is substantially vertical. Contaminated fluid (not shown) enters the electrode chamber 12 via the pair of inlet members 72. The arrangement of inlet apertures 74 initially directs the contaminated fluid away from the first electrode module 34, which results in a laminar flow of contaminated fluid across the electrode plates 42 of the first electrode module 34.

The hollow conduit 40 of the support body 36 inhibits the flow of contaminated fluid to inactive surfaces 62 of the electrode plates 42, and the flow of contaminated fluid adjacent to the inner surface 18 of the electrode chamber 12. This latter feature helps to eliminate the build up of contaminant particle deposits on the inner surface 18 and therefore helps to ensure that the first electrode module 34 remains easy to remove from the electrode chamber 12.

Once the contaminated fluid has passed through the hollow conduit 40 of the support body 36 it is directed from the electrode chamber 12 to the discharge conduits 22.

Each discharge conduit 22 may omit the plurality of weir members 26, and so the contaminated fluid may flow straight through each discharge conduit 22 and leave the electrocoagulation unit 10 via the fluid outlets 24. Such an arrangement preserves the Fe²⁺ ions in the discharged fluid.

In a different mode of operation, or if the electro coagulation unit 10 is used to treat a different contaminated fluid, each discharge conduit 22 may include a plurality of weir members 26. In this case the contaminated fluid directed from the electrode chamber 12 flows over the weir members 26 to facilitate the conversion of Fe²⁺ ions to Fe³⁺ ions.

Air or oxygen may be added via the aeration members to further facilitate this conversion.

The resistance across a sacrificial electrode (not shown), which has a lifetime similar to the electrode plates 42 in the first electrode module 34, may be monitored to determine when to replace one or more of the electrode plates 42.

Alternatively the voltage required to maintain a predetermined current through the electrode plates 42 may be monitored to determine when one or more of the electrode plates 42 needs replacing.

An operative may remove the first electrode module 34 from the electrode chamber 12 simply by lifting the first electrode module 34 out of the top 16 of the electrode chamber 12. The operative does not have to remove any seals and/or plates and covers in order to remove the first electrode module 34.

Once removed, the operative can replace the first electrode module 34 with another first electrode module 34, which may have a different configuration and/or electrodes 38 formed from a different material, for example. The other first electrode module 34 may be, e.g. more efficient for treating differently contaminated fluid, or have electrode plates 42 with a greater active surface area so as to be able to deal with a greater throughput of contaminated fluid within the fixed volume of the electrode chamber 12.

Alternatively, the operative can replace a damaged or worn first electrode module 34 with an identical first electrode module 34.

The operative may also repair/replace one or more electrode plates 42 of a removed first electrode module 34 before returning the first module 34 to the electrode chamber 12.

A second electrocoagulation unit according to a second embodiment of the invention is designated generally by the reference numeral 210, as shown schematically in FIG. 6.

The second electrocoagulation unit shares some features with the first electrocoagulation unit 10, and these are designated using the same reference numerals.

The second electrocoagulation unit includes a second electrode module 234 which is shown in partially exploded form in FIG. 7. The first and second electrode modules 34; 234 have some features in common with one another, and these are designated using the same reference numerals. In addition, the first and second electrode modules 34; 234 are interchangeable with one another.

The second electrode module 234 includes five support bodies 36, each support body 36 including a first support member 236 which extends through each electrode 38. One form of first support member 236 is a bolt 238 and a corresponding nut 240, which may be formed from nylon. However, differing numbers and other types of first support member are also possible.

Adjacent electrodes 38 in the second electrode module 234 are spaced from one another by five first spacer members 242. Each first spacer member 242 corresponds to a given first support member 236 which passes therethrough to secure the first spacer member 242 relative to the electrodes 38. Other embodiments may include a different number of first spacer members 242 between adjacent electrodes 38.

As a result it is possible easily to vary the spacing between adjacent electrodes 38 by varying the thickness or number of first spacer members 242 interposed between the adjacent electrodes.

In the second electrode module 234 shown the first support members 236 and the first spacer members 242 are electrically non-conducting.

Each electrode 38 in the second electrode module 234 extends laterally so as to lie adjacent to the corresponding wall 244 of the electrode chamber 12.

Each inactive surface 62 of the electrode plates 42 in the second electrode module 234 includes a cover member 246 secured thereto so as to lie between the inactive surface 62 and the corresponding wall 244 of the electrode chamber 12. This inhibits the flow of contaminated fluid over each inactive surface 62.

The second electrode module includes two second support members 64 which pass through two second spacer members 248.

In the second electrocoagulation unit 210, the second support members 64 and second spacer members 248 also electrically interconnect alternate electrode plates 42 to define a group of anodes 44 and a group of cathodes 46.

A fluid treatment apparatus according to another aspect of the invention is designated generally by the reference numeral 80.

The fluid treatment apparatus 80 shown in FIG. 9 includes two electrocoagulation units 10; 210 connected in series with a hydrogen peroxide unit 82, which, in turn, is connected in series to a separation unit 84. Each electrocoagulation unit 10; 210 may include a first and/or a second electrode module 34; 234

A third electrocoagulation unit (not shown) may include an electrode module 34; 234, which has stainless steel electrode plates 42.

Other preferred arrangements of fluid treatment apparatus (not shown) include:
(i) two series connected electrocoagulation units 10; 210 connected in series with a separation unit 84, which in turn is connected in series to a hydrogen peroxide unit 82;
(ii) a first electrocoagulation unit 10; 210 connected in series to a hydrogen peroxide unit 82, which is connected in series to a second electrocoagulation unit 10; 210 connected in series to a separation unit 84; and
(iii) a hydrogen peroxide unit 82 connected in series to two series connected electrocoagulation units 10; 210, which are connected in series to a separation unit 84.

The separation unit 84 may be or include a settling tank 86, as shown in FIG. 10. Fluid enters the settling tank 86 via a tank inlet 88 and exits via a tank outlet 90. Contaminant particles 92, e.g. sludge, may be removed via a tap 94 at the bottom of the tank 86 following settling.

A further separation unit 84 may be or include an air filter 96, as shown in FIG. 11(a).

The air filter 96 includes a filter inlet 98 through which contaminated fluid 99 enters the filter 96, a filter outlet 100 via which fluid leaves the filter 96, and an air inlet 102 through which a gas such as air or oxygen is introduced into the filter 96.

The air filter 96 also includes a diffuser 104 which includes a plurality of fluid transmission pores 106, together with a plurality of smaller, gas transmission pores 108.

A gas, e.g. air, is fed into the diffuser 104 and generates a stream of bubbles 110 which rise through the contaminated fluid 99 and urge suspended contaminant particles 112 to a surface 114 of the fluid 99.

Meanwhile, the larger fluid transmission pores 106 allow decontaminated fluid to pass through diffuser 104 to be collected via the filter outlet 100.

The air filter 96 may also include an aspirator (not shown) for sucking the contaminant particles 112 from the surface 114, a skimmer (not shown) for skimming the contaminant particles 112 from the surface 114, or a decanter (not shown) for decanting the contaminant particles 112 from the surface 114.

In each case the volume of collected contaminant particles 112 can be further reduced by evaporation or further treatment such as by filter press.

When treating fluid contaminated with dissolved organic carbon, or other organic based waste, it is desirable to include a hydrogen peroxide unit 82 in order to oxidise the organic contaminants in the fluid.

The hydrogen peroxide unit 82 includes a main chamber 116, which contains an anode 44 and a cathode 46. The anode 44 and the cathode 46 are made from blocks of reticulated vitreous carbon (RVC) in order to maximise the surface area of each electrode.

Alternatively, a dimensionally stable alloy (DSE), such as tantalum or titanium, can be used to form the anode 44.

The hydrogen peroxide unit 82 also includes two aeration members 32 located upstream of the anode 44 and cathode 46. Preferably each aeration member 32 includes a diffuser (not shown) with a relatively small pore size for generating small gas bubbles. In use the aeration members 32 help to ensure that the fluid passing through the hydrogen peroxide unit 82 is saturated with, e.g. oxygen.

The hydrogen peroxide unit 82 may also include a sacrificial anode (not shown) for releasing Fe²⁺ ions into the fluid passing through the unit 82.

Alternatively, the fluid treatment apparatus 80 may include a fluid conduit (not shown) between at least one electrocoagulation unit 10 and the hydrogen peroxide unit 82 for transferring Fe²⁺ ions from the electrocoagulation unit 10 to the hydrogen peroxide unit 82.

The presence of Fe²⁺ ions in the hydrogen peroxide unit 82 helps to improve the rate of degradation of organic compounds and promote the formation of suspended contaminant particles, which can then be coagulated and removed from the fluid.

The fluid treatment apparatus 80 may also include a silver ionisation unit (not shown) connected in series at the downstream end of the apparatus 80.

The fluid treatment apparatus 80 shown schematically in FIG. 9 also includes a power supply module 118, which provides power to the first and second electrocoagulation units 10 and the hydrogen peroxide unit 82. The power supply module 118 may include a vehicle engine and/or a renewable energy source such as a cycle-driven dynamo, a photovoltaic cell and a wind turbine. The fluid treatments apparatus 80 may also be powered by mains electricity or a methane source.

Other embodiments of fluid treatment apparatus 80 (not shown) may be powered by mains electricity.

In addition, the fluid treatment apparatus 80 shown includes a fluid pump 120 for pumping contaminated fluid through the electrocoagulation units 10 and the remainder of the fluid treatment apparatus 80.

The fluid treatment apparatus 80 may also include a gas pump 122 to supply the aeration members 32 with gas, e.g. air or oxygen.

1. An electrocoagulation unit, for removing contaminants from a fluid, comprising:
an electrode chamber, which in use has a top and a bottom, the chamber having a fluid inlet at or towards its bottom and being in fluid communication with at least one discharge conduit towards its top to direct fluid from the chamber towards a fluid outlet; and
an electrode module removable through the top of the electrode chamber and including at least one support body supporting a plurality of electrodes,
the electrode chamber and the electrode module cooperating with one another to restrict the flow of contaminated fluid to regions within the electrode chamber adjacent active surfaces of the electrodes.

2. An electrocoagulation unit according to claim 1 wherein the or each support body includes a first support member extending through each electrode.

3. An electrocoagulation unit according to claim 2 wherein adjacent electrodes are spaced from one another by at least one spacer member.

4. An electrocoagulation unit according to claim 3 wherein the or each first support member passes through one or more corresponding spacer members.

5. An electrocoagulation unit according to claim 1 wherein the electrodes extend laterally so as to lie adjacent to the electrode chamber.

6. An electrocoagulation unit according to claim 1 wherein each inactive surface includes a cover member secured thereto so as to lie between the given inactive surface and the electrode chamber.

7. An electrocoagulation unit according to claim 1 including a support body that defines a hollow conduit in which the electrodes are located and through which contaminated fluid flows.

8. An electrocoagulation unit according to claim 7 wherein the electrode module is removably located in the electrode chamber such that the support body spaces the electrodes from an inner surface of the electrode chamber.

9. An electrocoagulation unit according to claim 7 wherein the support body lies adjacent to each inactive surface of the electrodes.

10. An electrocoagulation unit according to claim 7 wherein the support body includes two cooperable body portions, which are separable from one another.

11. An electrocoagulation unit according to claim 10 wherein the support body includes at least one side member, the or each side member lying between the two body portions.

12. An electrocoagulation unit according to claim 1 wherein the or each support body is or includes a nonconductive material.

13. An electrocoagulation unit according to claim 1 wherein the electrodes are or include one or more of the following: aluminium, steel, stainless steel, copper, graphite, reticulated vitreous carbon and a dimensionally stable alloy.

14. An electrocoagulation unit according to claim 1 wherein the electrode module further includes at least one second support member, which passes through alternately spaced electrodes.

15. An electrocoagulation unit according to claim 14 wherein the electrode module includes a handle secured to at least one second support member to facilitate removal of the electrode module through the top of the electrode chamber.

16. An electrocoagulation according to claim 1 further including a DC power source electrically coupled to the electrode module.

17. An electrocoagulation unit according to claim 16 wherein the electrode module includes a pair of connecting members, each connecting member engaging two or more differing electrodes to define an electrical connection therebetween and being electrically coupled to the DC power source.

18. An electrocoagulation unit according to claim 1 wherein the or each discharge conduit includes at least one weir member between the top of the electrode chamber and the fluid outlet.

19. An electrocoagulation unit according to claim 1 wherein the or each weir member includes a plurality of perforations.

20. An electrocoagulation unit according to claim 1 wherein the or each discharge conduit includes an aeration member to introduce gas into fluid flowing through the discharge conduit.

21. An electrocoagulation unit according to claim 1 wherein the or each discharge conduit defines a helical path.

22. An electrocoagulation unit according to claim 1 further including at least one hydrogen collector.

23. An electrocoagulation unit according to claim 1 wherein the fluid inlet includes at least one inlet member, the or each inlet member including at least one inlet aperture, the or each inlet aperture being directed away from the electrode module to initially direct fluid away from the electrode module.

24. A fluid treatment apparatus, for removing contaminants from a fluid, comprising at least one electrocoagulation unit according to claim 1 and a separation unit wherein the electrocoagulation unit and the separation unit are fluidly connected in series.

25. A fluid treatment apparatus according to claim 24 including an electrocoagulation unit including an electrode module having stainless steel electrodes.

26. A fluid treatment apparatus according to claim 24 wherein the separation unit is or includes a settling tank.

27. A fluid treatment apparatus according to claim 24 wherein the separation unit is or includes an air filter including a diffuser to generate a stream of gas bubbles to urge any suspended contaminant particles to a surface of the fluid flowing through the separation unit.

28. A fluid treatment apparatus according to claim 27 wherein the separation unit includes an aspirator to suck suspended contaminant particles from an exposed fluid surface into a collection vessel.

29. A fluid treatment apparatus according to claim 27 wherein the separation unit includes a skimmer to skim suspended contaminant particles from an exposed fluid surface into a collection vessel.

30. A fluid treatment apparatus according to claim 27 wherein the separation unit includes a decantor to decant suspended contaminant particles from an exposed fluid surface into a collection vessel.

31. A fluid treatment apparatus according to claim 24 further including a series connected hydrogen peroxide unit having an anode and a cathode.

32. A fluid treatment apparatus according to claim 31 wherein the anode and the cathode are or include reticulated vitreous carbon.

33. A fluid treatment apparatus according to claim 31 wherein the anode is formed of or includes a dimensionally stable electrode alloy and the cathode is formed of or includes reticulated vitreous carbon.

34. A fluid treatment apparatus according to claim 31 wherein the hydrogen peroxide unit includes at least one aeration member located upstream of the anode and cathode.

35. A fluid treatment apparatus according to claim 31 wherein the hydrogen peroxide unit includes a sacrificial anode for releasing Fe²⁺ ions into the fluid passing through the hydrogen peroxide unit.

36. A fluid treatment apparatus according to claim 31 further including a fluid conduit between at least one of the electrocoagulation units and the hydrogen peroxide unit to allow the transfer of Fe²⁺ ions from the or each electrocoagulation unit to the hydrogen peroxide unit.

37. A fluid treatment apparatus according to claim 24 further including a series connected silver ionisation unit.

38. A fluid treatment apparatus according to claim 24 further including a power supply module including at least one of the following: a vehicle engine and a renewable energy source.
